(19) United States
(12) Patent Application Publication
(10) Pub. No.: US 2013/0211851 A1
(43) Pub. Date: Aug. 15, 2013

(54) Method for Patients to Sign Digitally Medical Bill before Submission to Insurer

(71) Applicants: Harvey Blum, Aventura, FL (US); Loren Donald Pearson, Miami Beach, FL (US)

(72) Inventors: Harvey Blum, Aventura, FL (US); Loren Donald Pearson, Miami Beach, FL (US)

(21) Appl. No.: 13/737,568

(22) Filed: Jan. 9, 2013

Related U.S. Application Data
(63) Continuation-in-part of application No. 12/886,562, filed on Sep. 20, 2010, now abandoned.
Application No. 12/886,562 is a continuation of application No. 10/273,553, filed on Oct. 19, 2002, now abandoned.
(60) Provisional application No. 60/357,771, filed on Feb. 19, 2002.

(51) Int. Cl. G06Q 20/40

(52) U.S. Cl. CPC G06Q 20/401; G06Q 20/102
USPC 705/2

(57) ABSTRACT

A system reduces health-insurance costs including the cost of fraud and overbilling by medical providers. The system uses an identification card to allow doctors to obtain a patient's medical history. The identification card can either hold the medical history itself or can link the provider to a database containing the medical history. A method reduces healthcare costs. The method includes the steps of providing a patient with a card including a computer-readable memory for storing a patient medical history, giving the card from the patient to a healthcare provider, storing the patient's medical history on a medium read with the card, and then diagnosing the patient with the medical history. A method for a patient to sign a bill digitally before a payor/insurer remits the bill is provided.

### CROSS-REFERENCE TO RELATED APPLICATIONS

This application is a Continuation-In-Part of application Ser. No. 12/886,562, filed Sep. 20, 2010, which is a Continuation of application Ser. No. 10/273,553, filed Oct. 19, 2002, now abandoned, which claims the benefit of U.S. Provisional Application No. 60/357,771, filed Feb. 19, 2002, now abandoned.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to health insurance. More specifically, the invention relates to systems for reducing costs, especially for patients who may be away from the typical provider.

2. Description of the Related Art

Previous insurance systems incur significant costs when an insured patient leaves their typical provider. For example, an insured patient has a medical problem while on vacation, out of town, or during a time when the doctor's office is closed: for example, a primary provider's office is closed due to the time of day or the doctor is on vacation. The patient has, fallen and is brought to a hospital or nearby office or patient becomes unconscious and is unable to communicate. The examining doctor does not know the patient's medical status before seeing him. The patient communicates what he is able to, and the doctor checks the patient's wallet and tries to gather as much information as possible.

Examination will provide some information, but not nearly enough. The doctor will stabilize the patient and then hospitalize the patient to find out what doctor needs to know. Such information includes prior medical conditions, previous attacks of the same condition for which the patient is now being treated, how many of these same attacks, and with what frequency these attack occur, what work-up in the office and hospital he has had for these same problems and others problems, the medications that the patient has taken, what changes in medications were made and when they were made, what surgical procedures were done and when they were done, what complications the patient has had from medication and surgery, what reactions to drugs, food, weather, seasons of the year and so forth; what immunizations that patient has had and when, what reactions has the patient had to these immunizations, and family history. The doctor will then order tests, depending on the results of the physical examination while the patient is in the hospital. This could range from blood work to a MRI and entail several days in the hospital along with consultation from different specialist. Medication will be given to patient that mayor may not be effective or cause negative reactions requiring further hospital days. In today's environment, there is a great deal of redundant and unnecessary medical workup done so as not to expose doctor to a lawsuit.

The current system is plagued by: redundancy, mismanagement, fraud and at times sub-par treatment of the patient.

At the present time, the patient goes to his/her primary care provider and is treated and leaves the office putting trust in the hands of the physician and office workers. In that, they will make the correct adjustments to the patient's records. The patient also, has no record of his/her own medical history, problems, and workups. In all fairness, whether or not the primary care providers have good intentions, mistakes, purposeful or not, are made. This can lead to inadequate treatment of the patient.

At the present time, a patient who wants to keep medical records must carry a complete hardcopy of them. This process is bulky, inefficient, and can lead to mistakes, whether fraudulent or inadvertent. Patients should have access to their medical history at all times—thus improving quality of care. At the present time, a patient arrives at the emergency room for any number of reasons. Most commonly, the patient feels ill, sick, hurt, etc. and his/her Primary-Care Physician (PCP) instructs the patient to go to the Emergency Room (ER), this commonly happens in the patient's local area. Other scenarios include patients from another state (very common in the southern states secondary to northerners traveling down south, i.e. “snow birds”) and these patients commonly are seen by unfamiliar ER physicians and are admitted by unfamiliar PCP's and/or specialists. This also happens in other countries. Again, unfamiliar physicians see the patients. At the present time, the physicians must rely on information from the patient, which is notoriously inaccurate, and he/she must try and obtain old records from wherever the patient has been previously treated. This is most often a prolonged, inefficient, inaccurate, and time-consuming effort. This can lead to sub-par treatment of the patient and most often leads to redundant laboratory procedures (i.e. “labs”), tests, procedures, and prolonged hospital stays.

The current system falls short of addressing these issues. The system now deals with this lack of universal patient information by placing restrictions on certain labs, tests, procedures, and hospital stays. This system was put in place in an attempt to restrain costs. The fact is that, if there were a system in place that provided patient information and ultimately allowed for direct access to the examination by physicians and healthcare providers such as Medicare and insurance companies, quality of care would be improved and healthcare costs would be decreased for the reasons stated above.

Computerized data encryption methods are known. One encryption system uses asymmetric keys, which are also known as public-private key encryption. Pretty Good Privacy or PGP is an example of an asymmetric cryptography that can be used to encrypt almost any data.

PGP supports message authentication and integrity checking. The latter is used to detect whether a message has been altered since it was completed (the message integrity property), and the former to determine whether it was actually sent by the person/entity claimed to be the sender (a digital signature). Because the content is encrypted, any changes in the message will result in failure of the decryption with the appropriate key. The sender uses PGP to create a digital signature for the message with either the RSA or DSA signature algorithms. To do so, PGP computes a hash (also called a message digest) from the plaintext, and then creates the digital signature from that hash using the sender's private key.

Smart cards are credit-card shaped devices that include an embedded microprocessor. The microprocessor control access to data stored on the card. A private key for asymmetric cryptography can be stored in a microprocessor of a smart card.

### SUMMARY OF THE INVENTION

It is accordingly an object of the invention to provide a system for reducing health-insurance costs including fraud for patients that overcomes the herein aforementioned disadvantages of the heretofore-known systems of this general type and that links a patient to a database including their medical history.

With new chip technology, a physician would have access to patients' medical history. If the physician had access to this information, he/she would be more efficient in treating the patient. This would reduce redundant tests, labs, and procedures, and would ultimately decrease hospital stays—thus decreasing healthcare costs. The chip technology according to the invention would help solve the other problems inherent in this system that relate, as described above, to inadvertent or fraudulent mistakes. If providers, Medicare, and private insurers had access to patients' information (i.e., labs, tests, procedures, hospital stays, etc.) and could monitor the accuracy of the information, this would cut down on mistakes (inadvertent or fraudulent) and decrease healthcare costs.

If the patient needs further workup elsewhere, his or her medical history can be accessed easily with the chip technology according to the invention and decisions about the patient's medical care made more accurately. Providers such as Medicare and insurance companies could have access to all visits, procedures, workups, and laboratory tests; whereas now these companies rely on physicians and their staff, hospitals and their staff, and clinics and their staff to accurately provide the information. This information again can be inaccurate whether purposeful or not and with new chip technology can be directly accessed thereby foregoing the necessity of relying on physicians, hospitals, clinics and their staff to provide the information. This obviously will cut down on fraudulent claims but also improve efficiency and most importantly improve quality of care.

Doctors will be provided with the information that is unavailable with the prior art. When the patient enters hospital or other facility for medical problems, all the information on the patient will be known. With this invention, the patient can be tracked medically 24/7, even while the primary care office is not available.

The invention encompasses a chip with all medical history and tests for a given patient on the chip. This chip can be carried in a patient's identification card, which is carried by him at all times. Each time the patient sees his doctor or visits his medical office, the chip is updated with new information. Updating of the chip can be accomplished by handing the card with the chip to office personnel. The patient is then seen by a doctor who either writes on a personal information manager such as one those sold under the trademark PALM PILOT® or dictates information directly into an office computer. This chip is then updated and card is then returned to the patient.

Other information available on chip would be blood type and possibly DNA.

The invention is a universal card that holds the patient's entire medical history and the hardware and software that allows access to this information.

The card will be given to the patient and the patient will bring it to the physician's office. The office has the hardware and software to access the data on the card for patients past medical history. The patient will be treated and physician will update the card with now data via dictation and or other data apparatus (i.e., PALM® technology, writing tablet DICTAPHONE®, etc.). At this time, either the data can be sent directly to the insurance company and/or Medicare or a signal can be sent to the above company and/or they can access the information directly. This will improve patient care by having a more precise record system and by having patients' histories at the physician's fingertips. This will reduce healthcare costs by decreasing unnecessary and redundant labs, tests, and procedures, and by decreasing the number of mistakes either inadvertent or fraudulent made by healthcare providers and their staff.

A further object of the invention is to prevent healthcare providers from billing for goods and services that were, in fact, never provided to the patient. A particular type of such misbilling occurs when a healthcare provider knowingly bills for goods and services that were known not to have been provided, which is a type of fraud. When the fraud is conducted to Medicare patients, the fraud is known as Medicare fraud. To prevent, a healthcare provider from misbilling, the patient is provided with a private key, preferably on a smart card. The patient reviews the bill and then “digitally signs” the bill by using his or her private key to encrypt a hash of the bill, which generates an encrypted message. The encrypted message along with the bill are provided to the payor/insurer. The payor/insurer decrypts the encrypted message with a public key that is associated with the patient's private key. The payor/insurer confirms that the bill being provided has been digitally signed by comparing the decrypted hash value with a hash value that it has generated from the bill. Bills that have been digitally signed can be processed for payment. Bills that do not comply can be investigated for patient verification, correction, denied, or referred for criminal investigation.

Other features that are considered as characteristic for the invention are set forth in the appended claims. Although the invention is illustrated and described herein as embodied in a system for reducing health-insurance costs including fraud for patients, it is nevertheless not intended to be limited to the details shown, since various modifications and structural changes may be made therein without departing from the scope of the invention and within the scope and range of equivalents of the claims. The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic rear side view of a healthcare card according to the invention.

FIG. 2 is a schematic view of a healthcare system.

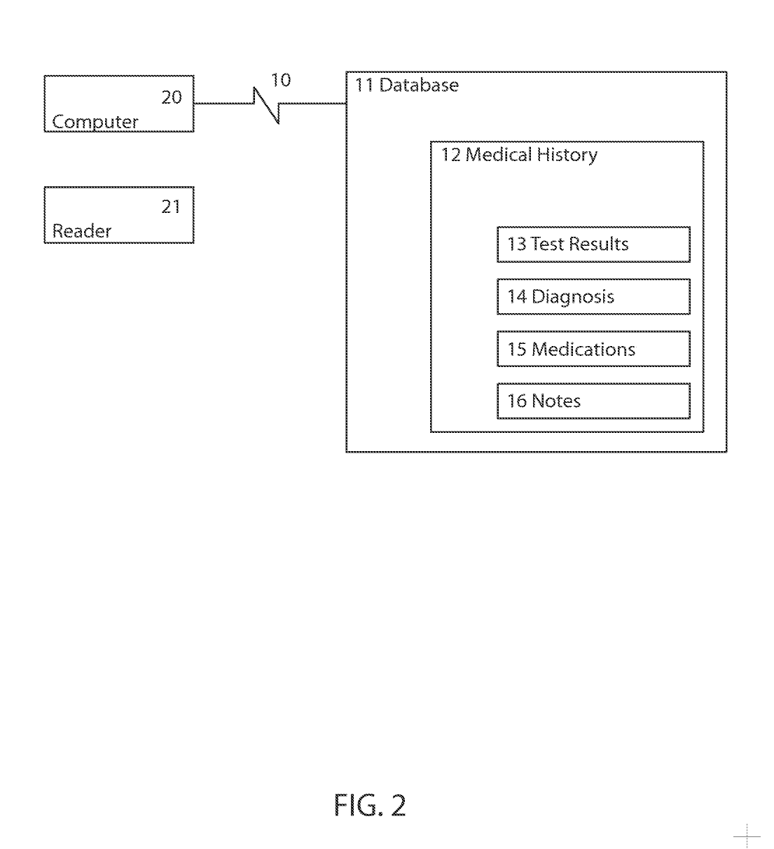

FIG. 3 is a flowchart of a method for updating and processing a patient's medial history.

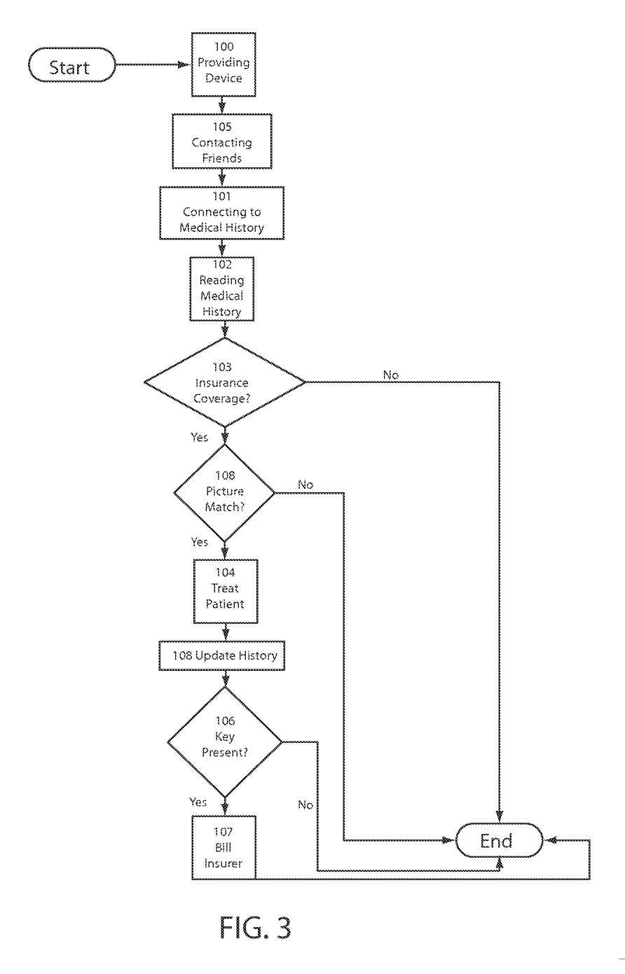

FIG. 4 is a schematic diagram of healthcare database according to the invention.

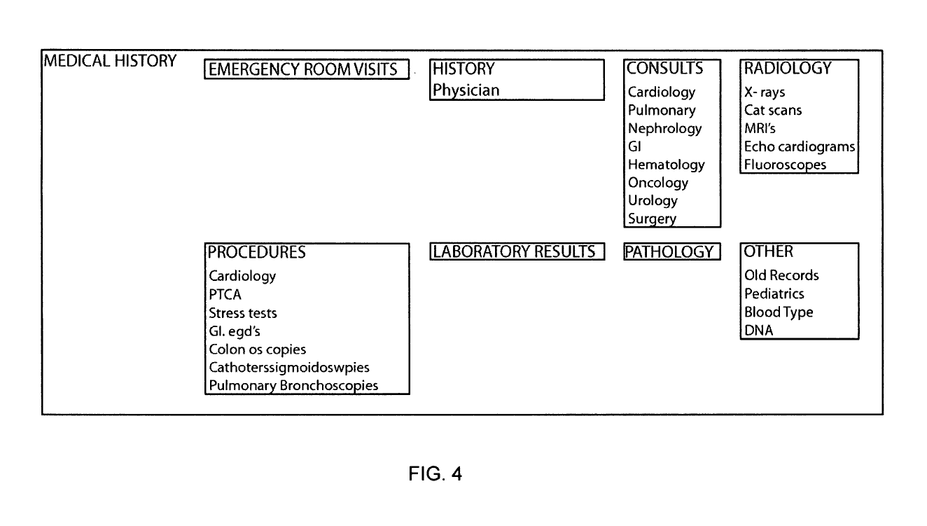

FIG. 5 is a flowchart showing a method for a patient to sign a bill digitally.

### DESCRIPTION OF THE PREFERRED EMBODIMENTS

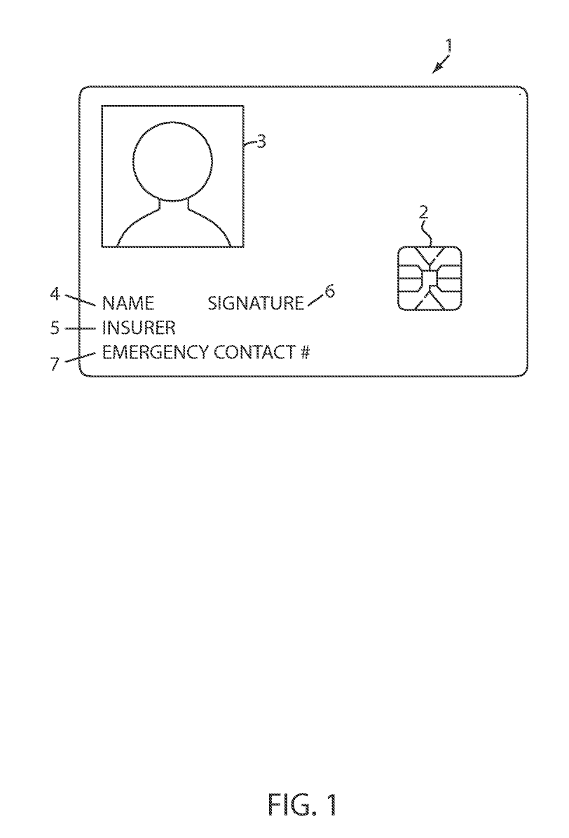

Referring now to the figures of the drawing in detail and first, particularly, to FIG. 1 thereof, there is seen a card 1. The card 1 includes patient information such as a photograph 3, name 4, signature 6, and an emergency contact telephone number 7.

In addition, the card 1 includes insurance information such as the name of the insurer 5. In addition, the card 1 can include coverage information such as an insurance plan name, limits of coverage, deductibles, and exclusions.

The card 1 includes a key, preferably a smartcard chip 2, required for unlocking a connection 10 to a medical history 12 of the patient.

Preferably, the medical history 12 includes each patient's test results 13, diagnoses 14, medications taken 15, and healthcare provider notes 16.

In one preferred embodiment, the medical history 12 is stored locally on the card 1 device with said patient information and said insurance information. In the case of a smartcard, the medical history 12 is stored electronically in the smartcard chip 2.

In an alternate embodiment, the medical history 12 is stored remotely on a networked database 11. A computer 20 with a smartcard reader 21 is connected via a network 10 to the database 11.

The computer 20 reads the medical history 12. Depending on the embodiment, the computer 20 reads the medical history 12 directly from the card 1 or from a database 11. The computer 20 is also used for supplementing the medical history 12 with new data. Preferably, the medical history 12 includes data in a standardized format for easy comparison.

The device, system, and methods reduce healthcare costs. By making medical histories available to providers, repeated tests are not necessary. For example, if a test were recently ordered, then a new doctor could access the old results and save the costs of conducting a new test. Likewise by including data in a standardized format, quality of care is improved because a healthcare provider now has baseline with which to compare new tests. For example, by comparing a new EKG to a previous one, a doctor can quickly determine whether a heart attack has occurred.

The invention encompasses a method for checking coverage. The insurance information can be used to determine the insurance coverage.

The invention encompasses a method for contacting family and friends. A healthcare provider possessing the card 1 can read the personal information and use it to contact the patient's friends and family.

According to the invention, the healthcare provider must provide the key before billing an insurer.

According to the invention, a photograph of the patient is provided on the device. The healthcare provider confirms the identity of the patient by checking the photograph.

A system for tracking diseases among patients includes a database and the card 1. The database contains a respective medical history for each of the patients. A card 1 for each respective is provided. Each card 1 includes the respective patient information, insurance information, and a key required for forming a connection to said database. The card 1 is required for updating the respective medical history of the patient. In the preferred embodiment, the medical histories of the patients are anonymous.

A method for tracking diseases among patients is encompassed by the invention. The method includes providing a database that contains medical histories of the patients. In the next step, each patient in the database is identified with a card 1. Patient information is provided on the card 1. Insurance information is provided on the card 1. A key is included on the card 1. The key is required to form a connection to the database. An occurrence of a disease is written to the patient's respective medical history in the database. The frequency of the disease can then be monitored by tracking the data in the database.

A patient with a card 1 in hand, pocket, or handbag, or other arrives in an ER. Not withstanding or dependant upon the patient's state of health, the patient has all of her medical history in or on the person. In other words, if the patient is incapacitated (i.e. secondary to stroke, syncope, drug use/abuse, etc.), the patient's medical history can be obtained. Thus, a system will be in place and made common place and known to EMS/fire rescue that they are aware that this card 1 is present and attainable at the patients household and is located in purse or ‘box”, or around neck on chain, i.e. dog tags.

This patient has a health related problem and is triaged by the triage nurse (or whatever system that particular hospital has in place) in the ER. The nurse (or other) places the card 1 in a card reader (provided by company) and the patient's information goes into the hospital computer system and/or ER computer system. The ER physician is able to access this information and is better able to treat patient. The ER physician can determine if this particular problem has been present before, what and how they were treated, and what workups were done in the past.

This will cut down on healthcare costs by decreasing unnecessary and redundant labs, tests, and procedures. In addition, healthcare costs are reduced by decreasing the number of mistakes either inadvertent or fraudulently made by healthcare providers and their staff. This will lead to improvement of patient care secondary to the same reasoning as above and will decrease hospital costs and thus healthcare costs as described above.

The ER physician at some time in the course of treatment makes a decision to admit the patient or not. The above information will help in making this decision. Once the decision is made to admit the patient, a primary care physician and/or specialist is called to admit. At this time, the PCP or specialist makes the decision to admit or not. With a full history in hand, the physician is better able to make this decision.

The patient is treated. The card 1 is either updated by the medical records department or other. At this point, Medicare and/or insurance companies can access this information. Again, this will cut down on healthcare costs by decreasing unnecessary and redundant labs, tests, and procedures. In addition, by decreasing the number of mistakes either inadvertent or fraudulent made by healthcare providers and their staff.

This card 1 can be used anywhere in the world.

The database can include data organized into the following hierarchy.

| | |
|---|---|
| I. Emergency Room Visits | |
| (from most recent dates) | |
| II. History and Physician | |
| III. Consults | Divided into subspecialties i.e.: cardiology, |
| | pulmonary, nephrology, GI, heme/oncology, |
| | urology, surgery, etc. |
| IV. Radiology | X-rays, CAT Scans, MRI's, |
| | Echocardiograms, Fluoroscopes, etc. |
| V. Procedures | Cardiology Caths/PTCA, stress tests (all |
| | types), etc.; GI. egd's, colonoscopies, |
| | siginoidoswpies pulmonary bronchoscopies, |
| | etc. |
| VI. Labs | |
| VII. Pathology | |
| VIII. Other: | Old records including pediatrics (unless card |
| | already given to person at childbirth or as a |
| | child to be maintained by parent or |
| | guardian), blood type, and possibly DNA. |

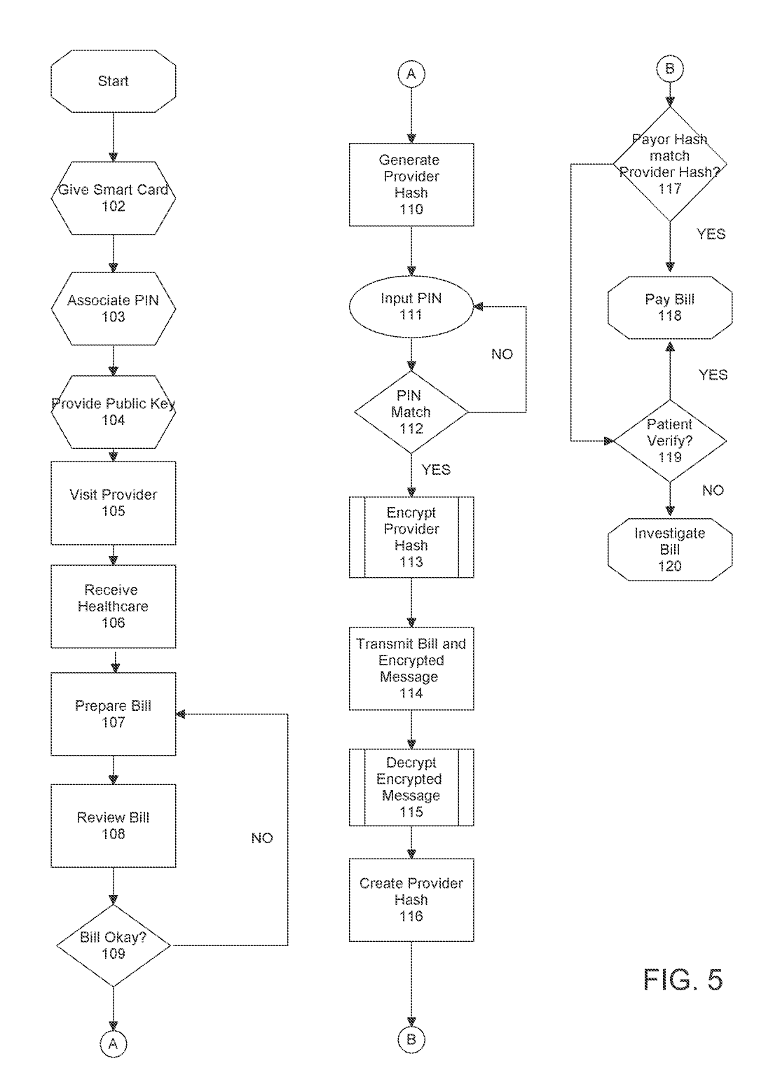

FIG. 5 is a flowchart showing a method for a patient to sign a bill digitally that can be used to prevent a healthcare provider from requesting reimbursement from an insurer for healthcare (i.e. goods and services) that was in fact never provided to the insured patient.

To begin, in step 102 a patient is provided with a smart card. The smart card contains a private key associated with the insured/patient. The private key can be provided in other formats and on other media. However, a smart card is particularly preferred because of the difficulty a hacker has in accessing the data.

In step 103, a personal identification number (i.e. a PIN) is associated with the smart card. An example of a preferred embodiment of a PIN is a four digit number. The PIN is given to the patient and is used to access the private key. The private key is preferably a one-way private key. That is, the private key can be used to encrypt date. However, the private key cannot be used to decrypt data.

In step 104, a public key is provided to a payor, preferably, a private or public insurer. The public key is associated with the insured/patient. The public key can decrypt an encrypted message that was encrypted using the associated private key.

In step 105, the patient visits the healthcare provider. The healthcare provider sells treatment, medicine, or goods to the patient in step 106. Next, the healthcare provider creates a bill in step 107. In steps 108 and 109, the patient reviews the bill. In particular, the patient is reviewing the listing of goods and services that the healthcare provider is alleging were delivered to the patient. If goods and services that were never provided are included on the bill, the patient should reject the bill. If the patient approves the bill, the bill can continue processing. The patient can request the bill to be corrected and reprepared.

Once approved, the bill is hashed using an appropriate algorithm in step 110 to generate a provider hash.

In step 112, the patient inserts his or her smart card in a smart card reader of the healthcare provider. The patient enters his or her PIN number. If the PIN number matches the PIN number associated with the card, the smart card continues the encryption process.

In step 113, the provider hash is inputted into smart card and the smart card outputs an encrypted message by using an encryption method that utilizes the private key. The encrypted message is a digital signature that is unique to the private key and the bill.

In step 114, the bill and the associated encrypted message are sent to the payor (e.g. private insurer, public insurer, or single payor).

In step 115, the payor decrypts the encrypted message using the public key to recreate the provider hash.

In step 116, the payor generates a payor hash from the bill transmitted from the healthcare provider to the payor.

In step 117, the payor hash is compared to the provider hash. If the payor hash and the provider hash are identical, then the bill that was transmitted to the payor was the bill that the patient digitally signed. As a result, the payor can be assured that the insured/patient confirms receipt of the billed goods and services. So, the payor can reimburse the healthcare provider for the goods and services listed on the bill as shown in step 118.

In cases where the payor hash and the provider hash do not match, the payor/insurer can investigate the claim as shown in step 120. An initial investigation would be to contact the patient and request confirmation from the patient that the questioned goods and services were in fact delivered. In instances, where the patient is wrongfully withholding his or signature on a bill, the healthcare provider can be provided an opportunity to show the payor/insurer that the goods and services were in fact delivered.

What is claimed is:

1. A method for preventing a healthcare provider from submitting a bill to an insurer for a good or service that was not delivered to a patient, which comprises:
providing a patient with a smart card, said smart card including a private key of the patient;
associating a PIN number with said private key;
providing a public key associated with said private key to a healthcare insurer;
providing a healthcare good or service to the patient;
preparing a bill for said healthcare good or service with a computer;
requesting the patient to review the bill;
generating a provider hash value based on said bill;
inputting said smart card into a smart card reader;
inputting said provider hash value in said smart card reader;
entering a patient-entered PIN number of the patient by said patient;
generating an encrypted message with said smart card from said private key and said provider hash value when said patient-entered PIN matches said PIN associated with said private key;
transmitting said bill and said encrypted message to said healthcare insurer;
generating a payor hash value from said bill received by said healthcare insurer;
decrypting said encrypted message received by said healthcare insure into said provider hash value by using said public key; and
paying said bill when said payor hash value matches said provider hash value.

2. A method for preventing a healthcare provider from submitting a bill to an insurer for a good or service that was not delivered to a patient, which comprises:
providing a patient with a private key associated with the patient;
providing a public key associated with said private key to a payor;
providing a healthcare good or service to the patient;
preparing a bill for said healthcare good or service with a computer;
generating a provider hash value based on said bill;
generating an encrypted message from said private key and said provider hash value;
transmitting said bill and said encrypted message to said payor;
generating a payor hash value from said bill received by said payor;
decrypting said encrypted message into said provider hash value by using said public key; and
paying said bill when said payor hash value matches said provider hash value.

3. The method according to claim 2, which further comprises:
associating a PIN with said private key;
requesting a patient-entered PIN before encrypting the provider has value; and
only generating the encrypted message when said patient-entered PIN matches said PIN associated with said private key.

4. The method according to claim 2, which further comprises not paying the bill until the patient verifies that said good or service was provided to the patient.

5. The method according to claim 2, which further comprises requesting confirmation from the patient when said provider hash value does not match said payor hash value.

6. The method according to claim 2, which further comprises:
providing the patient with a smartcard, said smart card containing said private key; and
generating said encrypted message by inputting said provider hash value into said smart card.

7. The method according to claim 2, which further comprises requesting the patient to verify said bill before generating said encrypted message.

8. The method according to claim 2, which further comprises encrypting said provider hash value while the patient is at a location where said healthcare good or service is delivered to the patient.
